(19) United States
(12) Patent Application Publication
(10) Pub. No.: US 2002/0041457 A1
(43) Pub. Date: Apr. 11, 2002

(54) Color filter utilizing two complementary colors

(76) Inventors: Wei-Chen Liang, Hsinchu (TW); Pin Chang, Hsinchu (TW); Wen-Chien Huang, Chu-Pei City (TW); Heng-Chung Wu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/940,455

(22) Filed: Aug. 29, 2001

(30) Foreign Application Priority Data
Oct. 6, 2000 (TW) 89217356

(51) Int. Cl. G02F 1/1335

(52) U.S. Cl. 359/885

(57) ABSTRACT

The present invention provides a color filter utilizing two complementary colors having a plurality of color units each comprised of a primary color and its complementary color. A black frame can be further overspread on the periphery of the two colors. A color filter having two complementary colors is exploited in the present invention so as to achieve the object of multi-color display. Because the present invention has the characteristics of low price, simple structure, and easy fabrication, it can be widely applied to display devices of portable products.

### FIELD OF THE INVENTION

The present invention relates to a liquid crystal display and, more particularly, to an improved structure of the color filter in a liquid crystal display.

### BACKGROUND OF THE INVENTION

No matter adopting what display way, all flat panel display devices exploit various variations and combinations of the three primary colors (red, green, and blue) to achieve the object of color display. Although flat panel display devices utilizing the three primary colors can achieve full-color display, they are not applicable in some ranges of application where requirement of the quality of color display is low. With the LCD as an example, the characteristics of electrical induction and optical anisotropy of liquid crystal are exploited. The liquid crystal has good molecular orientation and fluidity characteristics. When the liquid crystal is subject to external excitations such as illumination, heat, electrical field, and magnetic field, its molecular orientation will easily be altered so that brightness contrast will change or other special electrical and optical effects will emerge when light penetrates through it. The LCD has the advantages of light weight, convenient portability, and small size. The LCD also dissipates less power. Therefore, the LCD has been extensively used in electronic and information products.

Basically, the idea of the whole LCD technology is to use the liquid crystal as a gate to block light or let light penetrate through. When a voltage signal is applied on an LCD, transparent electrodes matching with a color filter can let light penetrate through or be absorbed by the LCD so that color images can be display. The color filter has a plurality of color units therein. Each of the color units is composed of the three primary colors of red, green, and blue and has a black frame overspread on the periphery thereof. The color filter is used to cover over pixels so as to achieve color display. Because the color filter exploits the effect of light absorption to display color images, the higher color density, the lower whole transmission ratio. That is, there is a tradeoff between the brightness and the color intensity of the display device. Moreover, although a full-color display device having a color filter utilizing the three primary colors has better quality of color display, because the structure thereof is more complicated, more electrodes and drive components are required so that the cost is relatively high. Therefore, it is not suitable to other cheap portable products having lower requirement of the quality of color display.

### SUMMARY OF THE INVENTION

The primary object of the present invention is to provide a color filter utilizing two complementary colors, which utilizes the variations and combinations of two colors to achieve multi-color display so as to be suitable to some portable products having lower requirement of the quality of color display.

Another object of the present invention is to provide a color filter, which has a low price and a simple structure and can be easily produced so that a color display device utilizing it requires fewer electrodes and drive components.

According to the present invention, a color filter utilizing two complementary colors has a plurality of color units each comprised of a primary color and its complementary color. The variations and combinations of the two colors are exploited so as to achieve the object of multi-color display.

The various objects and advantages of the present invention will be more readily understood from the following detailed description when read in conjunction with the appended drawings, in which:

### BRIEF DESCRIPTION OF THE DRAWINGS

FIG. 1 is a cross-sectional view of the structure of an LCD according to an embodiment of the present invention;

FIG. 2 is a schematic diagram of a color filter of the present invention;

FIGS. 3(A) to 3(E) show various embodiments of the present invention, respectively;

FIG. 4 is a schematic diagram of a color filter having a black frame according to an embodiment of the present invention.

### DETAILED DESCRIPTION OF THE PREFERRED EMBODIMENTS

The present invention is characterized in that the color filter of an LCD exploits the variations and combinations of two complementary colors to achieve the object of multi-color display. Therefore, the present invention is applicable to ranges of application different from those of conventional LCDs. The characteristics of the present invention will be illustrated by describing an LCD below.

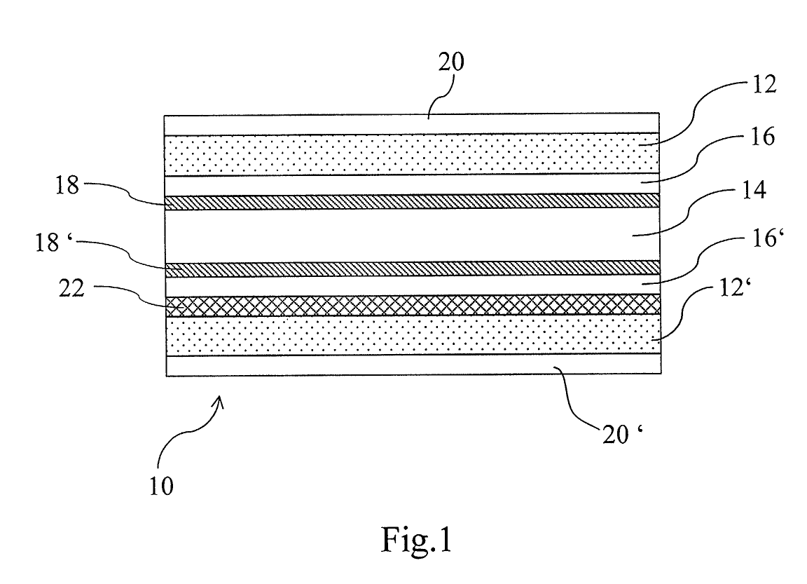

As shown in FIG. 1, an LCD 10 comprises an upper and a lower transparent glass substrates 12 and 12′, which are parallel spaced. Each of the two transparent glass substrates 12 and 12′ has a corresponding opposite surface. A liquid crystal layer 14 is situated between the upper and the lower glass substrates 12 and 12′. Transparent electrodes 16 and 16′ and orientation films 18 and 18′ cover over the opposite surfaces of the upper and the lower glass substrates 12 and 12′. Two polarizing plates 20 and 20′ are arranged on the outer surfaces of the upper and the lower glass substrates 12 and 12′, respectively. A color filter 22 is sandwiched between the lower glass substrate 12′ and the transparent electrode 16′.

In other words, in the above LCD 10, the transparent electrode 16, the orientation film 18, the liquid crystal layer 14, the orientation film 18′, the transparent electrode 16′, and the color filter 22 are sandwiched in order from top to bottom between the upper and the lower glass substrates 12 and 12′. Additionally, the above color filter 22 can also be arranged between the upper glass substrate 12 and the transparent electrode 16 so that the color filter 22, the transparent electrode 16, the orientation film 18, the liquid crystal layer 14, the orientation film 18′, and the transparent electrode 16′ are sandwiched in order from top to bottom between the upper and the lower glass substrates 12 and 12′.

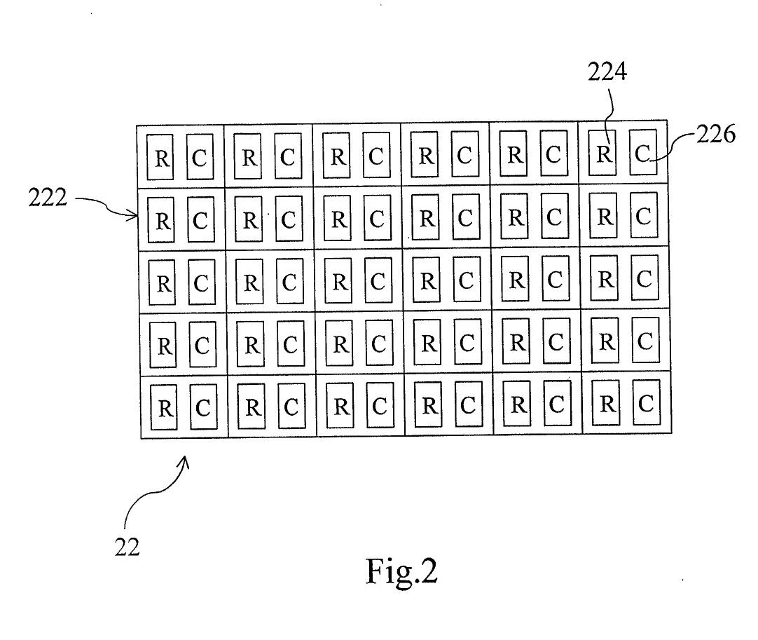

The color filter 22 has a plurality of color units 222. As shown in FIG. 2, each color unit 222 comprises a primary color 224 and its complementary color 226, generally being the red color (R) and the cyan color (C). The primary color 224 and its complementary color 226 are properly arranged in matrix form. When a voltage signal is applied on the LCD, light can penetrate through or be blocked through the functions of the transparent electrodes 16 and 16′ and the color filter 22 matching with the liquid crystal layer 14. Therefore, the brightness contrast of pixels of the primary color and its complementary color of the LCD can be adjusted so that the effect of a series of different colors can be achieved. The obtained colors will distribute over the arc line defined by the primary color and its complementary color.

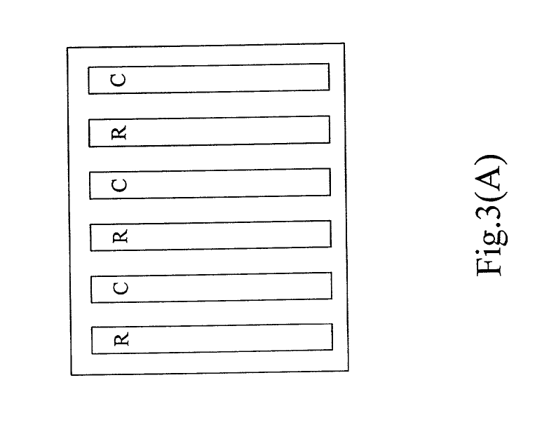

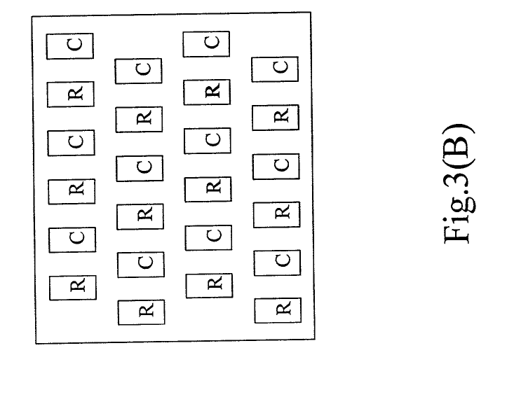

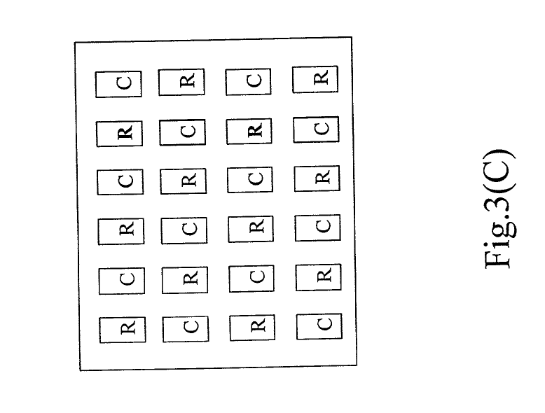

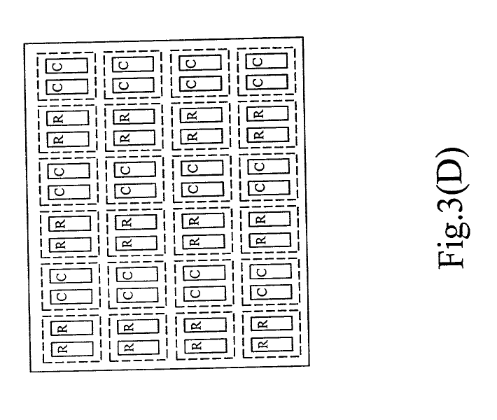

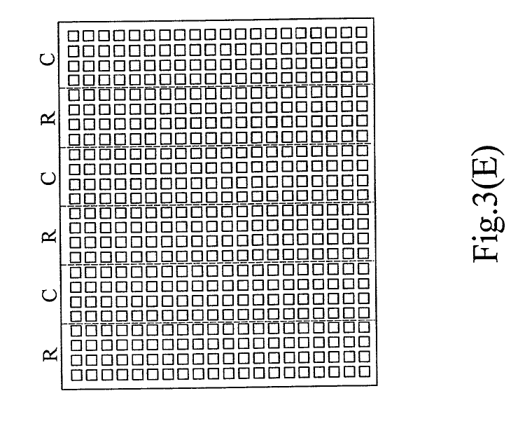

Except the combination of the red color and the cyan color, the primary color and its complementary color used by the color filter of the present invention can be the combination of the blue color and the yellow color or the combination of the green color and the magenta color. Moreover, except the matrix form shown in FIG. 2, the way of arrangement of the colors on the color filter can be other ways of arrangement. FIG. 3(A) shows the situation that the primary color and its complementary color are arranged in bar form. FIG. 3(B) shows the situation that the primary color and its complementary color are arranged in cross form (mosaic form). FIG. 3(C) shows the situation that the primary color and its complementary color are arranged in checker form. FIG. 3(D) shows the situation that each of the primary colors and each of the complementary colors shown in FIG. 2 are further divided into two parts so as to increase the transmission ratio. FIG. 3(E) shows the situation that each of the color bars shown in FIG. 3(A) is further divided into a plurality of small grids.

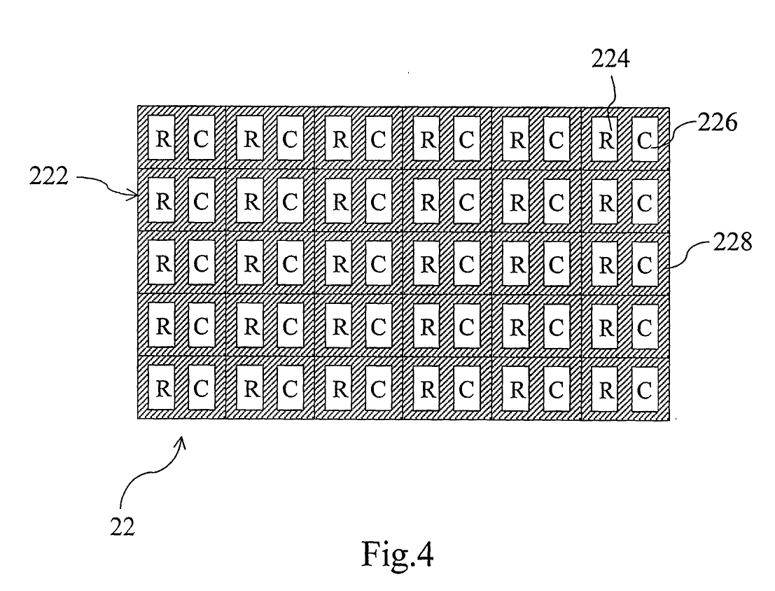

As shown in FIG. 4, a black frame 228 can be further overspread on the periphery of the primary colors 224 and the complementary colors 226 to shield the seam of the color filter 22 so that color display will not be influenced. Moreover, adding the black frame 228 enhances the contrast effect of color.

The present invention provides a color filter utilizing two complementary colors, wherein the variations and combinations of two colors are exploited to achieve multi-color display so as to be suitable to some portable products having lower requirement of the quality of color display. Because only two colors are used in the color filter of the present invention, fewer electrodes and drive components are required when the present invention is applied to an LCD. Therefore, the present invention has the characteristics of simple structure, high transmission ratio, low price, and easy fabrication so that it can be widely applied to cheap portable products such as video games, screens of cellular phones, and personal digital assistants (PDAs). Because display screens of these products have lower requirement of the quality of color display, full-color display of conventional display devices is not required. Besides, the present invention has the characteristic of high transmission ratio and the brightness of the display device is thus sufficient so that background light is not required. Therefore, one of the most important requirements of portable products—power saving—can be achieved. Furthermore, if expensive display devices of prior art utilizing the three primary colors are applied to portable products, their prices will go through the roof so as to deteriorate their sells. For display screens of small products, multi-color display is satisfactory.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A color filter utilizing two complementary colors having a plurality of color units, each of said color units being comprised of a primary color and its complementary color.

2. The color filter utilizing two complementary colors as claimed in claim 1, wherein said primary color is red, and said complementary color is cyan.

3. The color filter utilizing two complementary colors as claimed in claim 1, wherein said primary color is blue, and said complementary color is yellow.

4. The color filter utilizing two complementary colors as claimed in claim 1, wherein said primary color is green, and said complementary color is magenta.

5. The color filter utilizing two complementary colors as claimed in claim 1, wherein a black frame can be further overspread on the periphery of said primary color and said complementary color.

6. The color filter utilizing two complementary colors as claimed in claim 1, wherein the way of arrangement of said primary color and said complementary color can be selected among the matrix form, the bar form, the cross form, the small grid form, or the checker form.
